(19) United States
(12) Patent Application Publication
(10) Pub. No.: US 2003/0089133 A1
(43) Pub. Date: May 15, 2003

(54) Method of forming a glass article by collapsing an annular passage of a preform during draw

(75) Inventors: Julie E. Caplen, Painted Post, NY (US); Jean-Philippe de Sandro, Beaconsfield (CA); Daniel W. Hawtof, Painted Post, NY (US)

Correspondence Address: FOLEY AND LARDNER, SUITE 500, 3000 K STREET NW, WASHINGTON, DC, 20007, US

(73) Assignee: CORNING INCORPORATED

(21) Appl. No.: 10/157,910

(22) Filed: May 31, 2002

Related U.S. Application Data
(60) Provisional application No. 60/295,107, filed on May 31, 2001.

(51) Int. Cl. C03B 37/018

(52) U.S. Cl. 65/391; 65/419

(57) ABSTRACT

A method of manufacturing a glass article, such as an optical fiber. The method comprises the steps of providing a glass tube with an annular passage, forming a preform from the glass tube while maintaining the annular passage, and drawing the preform into the glass article such that the annular passage closes during drawing. The preform is formed by the steps of providing glass on an inner surface of the glass tube while maintaining the annular passage and providing glass on an outer surface of the glass tube. The preform has a predetermined value α that is an inner diameter of the preform after providing glass on the inner surface divided by an outer diameter of the glass tube. The preform has a predetermined value β that is the inner diameter of the preform after providing glass on the inner surface divided by the outer diameter of the preform.

### CROSS REFERENCE TO RELATED APPLICATION

This application claims the benefit of U.S. Provisional Application No. 60/295,107, filed May 31, 2001.

### BACKGROUND OF THE INVENTION

1. Field of the Invention

The invention relates generally to a method of manufacturing a glass article and, more particularly, to a method of manufacturing an optical fiber by drawing a preform while closing an annular passage in the preform.

2. Description of the Related Art

An optical fiber is typically manufactured by forming an optical fiber preform and drawing an optical fiber from the preform. Conventional processes for forming the preform include chemical vapor deposition (CVD) processes, such as outside vapor deposition (OVD), vapor axial deposition (VAD), modified chemical vapor deposition (MCVD), and plasma activated chemical vapor deposition (PCVD).

In typical MCVD and PCVD processes, a preform is formed by depositing glass on the inner surface of a glass tube. The deposited glass provides the material that ultimately forms the core and a portion of the cladding of the optical fiber. The glass tube provides the material that ultimately forms at least a portion of the cladding of the optical fiber.

In the MCVD process, for example, layers of doped silica are deposited onto the inner surface of the glass tube. The doped silica is deposited in thin layers of soot through a vapor deposition technique. As the soot is being deposited, it is sintered into glass by, for example, an oxygen-hydrogen torch heating the outside surface of the tube. Often the initial thin layers of soot have the composition of the cladding material and subsequent layers of soot have the composition of the core material. For example, the soot that will form the core often has silica doped with germania to increase its index of refraction.

In the PCVD process, a combination of gases is injected into the silica glass tube. A resonator is then traversed along the length of the tube and couples microwave energy into the gases. The gases react with one another and plasma is formed. The plasma is a source of direct heat, which causes the gas vapors to oxidize and form glass layers on the inner surface of the glass tube.

In both the MCVD and the PCVD processes, an annular passage remains in the intermediate article resulting from deposition of glass layers on the inner surface of the glass tube. In both processes, the annular passage of the intermediate article is typically closed, to form the optical fiber preform from which the optical fiber is drawn. Conventionally the intermediate article is heated so that the glass becomes molten and is rotated while a slight positive pressure is applied to cause the annular passage to collapse.

Use of these conventional processes has some disadvantages. For example, these processes can cause voids to form in the preform as the annular passage closes. The voids can remain when the preform is drawn into fiber and adversely affect the transmission properties of the fiber.

Another disadvantage of conventional processes is that the cross-sectional profile typically does not remain symmetric in the radial direction as the annular passage closes. FIG. 1 shows a cross-sectional profile of a preform, indicated generally at 10, formed using a conventional process. The preform 10 includes a center point 12 surrounded by layers of glass 14 and 16. In FIG. 1, glass layers 14 nearer the center point 12 have an irregular, asymmetric shape, as a result of the use of a conventional process to collapse the annular passage. Only at locations farther from the center point 12 do the layers of glass 16 begin to form more symmetrical and concentric circles or rings about the center point 12.

It is expected that the non-symmetrical layers of glass 14 in the preform 10 will result in asymmetry in an optical fiber drawn from the preform 10. Additionally, it is expected that the asymmetry will be present, in varying magnitudes and shapes, along the length of the preform 10 (and the resulting optical fiber).

An asymmetric profile can cause variations in the core diameter along the length of the fiber core so that transmitted light “sees” a different core cross-sectional area at different points along the length of the optical fiber. In addition, an asymmetric profile can reduce the bandwidth of laser launched multimode fibers.

An asymmetric profile is also believed to be one of the main causes of polarization mode dispersion (PMD). PMD is a form of dispersion which results when one orthogonal component of light travels faster than another orthogonal component. The two components of light; electric and magnetic, are sinusoidal. PMD is a severe problem when it is present to any significant degree in single mode fibers, for at least the reason that it limits the rate of data transmission in fiber-based telecommunications systems.

More specifically, single mode fibers and multimode fibers both have an outside diameter of generally about 125 microns. However, single mode fibers have a smaller core diameter, e.g., about 8 microns. This dimensional relationship makes single mode fibers extremely sensitive to PMD. Consequently, eliminating PMD is a significant goal in fiber manufacturing, especially in single mode fibers.

In contrast to the small core size of single mode fibers, the core region of a multimode fiber commonly has a diameter of 50 or 62.5 microns. In multimode fibers, non-symmetric closure of the annular passage has resulted in the inability to tune refractive index profiles in the inner-most portion of the fiber adjacent the centerline. As a result, lasers used to launch light into such fibers are often offset some distance from the centerline of the multimode fiber to avoid this region of non-symmetric hole closure.

The spinning of an optical fiber during draw operation is one way to reduce PMD. Spinning involves a process where the fiber is mechanically twisted along its centerline axis while being drawn from the molten root of the preform. The irregularities of the components of light average their dispersion and therefore lower the overall PMD in the fiber. Spinning is a complicated process for mitigating the effects of non-symmetric closure of the annular passage and can impede the draw speed, cause coating geometry perturbations, and can reduce the strength of the optical fiber. Therefore, it is most desirable to design a fiber having a low PMD without having to resort to such spinning techniques.

The present invention is directed to overcoming or at least reducing the effects of one or more of the problems set forth above.

### SUMMARY OF THE INVENTION

One aspect of the present invention relates to a method of manufacturing an optical fiber. The method comprises the steps of providing a glass tube with an annular passage, and forming a preform by the steps of providing glass on an inner surface of the glass tube while maintaining the annular passage, and providing glass on an outer surface of the glass tube. The preform has a first predetermined value a that is a diameter of the annular passage after providing glass on the inner surface divided by an outer diameter of the glass tube. The preform has a second predetermined value β that is the diameter of the annular passage after providing glass on the inner surface divided by an outer diameter of the preform after providing glass on the outer surface. The preform is drawn to form an optical fiber while closing the annular passage.

Another aspect of the present invention relates to a method of manufacturing a glass article. The method comprises the steps of providing a glass tube with an annular passage, and forming a preform by the steps of providing glass on an inner surface of the glass tube while maintaining the annular passage, and providing glass on an outer surface of the glass tube. The preform has a first predetermined value α that is a diameter of the annular passage after providing glass on the inner surface divided by an outer diameter of the glass tube. The preform has a second predetermined value β that is the diameter of the annular passage after providing glass on the inner surface divided by an outer diameter of the preform after providing glass on the outer surface. The preform is drawn to form an optical fiber while closing the annular passage.

Yet another aspect of the present invention relates to a method of manufacturing an optical fiber. The method comprises the steps of providing a glass tube with an annular passage, and forming a preform by the steps of providing glass on at least an inner surface of the glass tube while maintaining the annular passage to provide the preform having a predetermined value β that is the diameter of the annular passage divided by the outer diameter of the preform. The preform is drawn to form an optical fiber while closing the annular passage.

A further aspect of the present invention relates to a glass article, such as an optical fiber, made in accordance with the disclosed methods.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate an embodiment of the invention and together with the description, serve to explain the principles of the invention.

FIG. 1 is a drawing, based on data, of an expected cross-sectional profile of a preform formed using a conventional process and an expected cross-sectional profile of an optical fiber formed from the preform;

FIG. 2 is a drawing, based on data, of an expected cross-sectional profile of an optical fiber formed in accordance with the present invention;

FIG. 3 is a cross-sectional view of a glass tube with glass deposited thereon;

FIG. 4 is a side view of a preform disposed above a draw furnace with a sealed annular passage.

FIG. 5 is a side view of a preform located within a draw furnace with an annular passage open at the top of the preform.

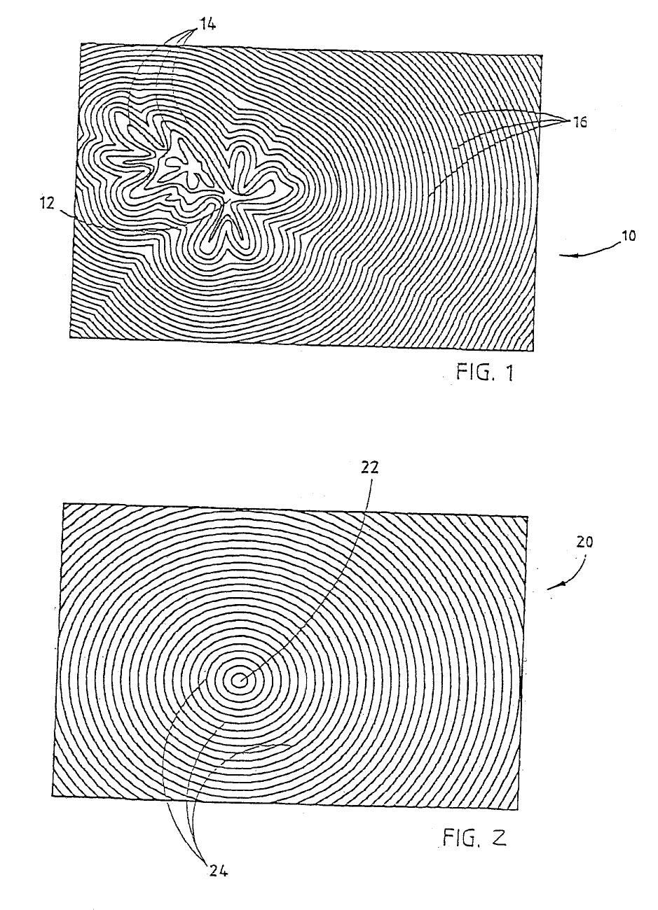

### DETAILED DESCRIPTION OF THE PREFERRED EMBODIMENTS

Reference will now be made in detail to present, preferred embodiments of the invention, an example of which is illustrated in the accompanying drawings. Wherever possible, the same reference numerals will be used to designate the same or similar parts.

The present invention relates to a method of manufacturing a glass article, such as an optical fiber. The method includes the steps of providing a glass tube with an annular passage, forming a preform from the glass tube while maintaining the annular passage, and drawing the preform into a glass article, preferably an optical fiber, such that the annular passage closes during drawing.

It has been determined that, instead of using conventional processes for closing the annular passage, it can be closed by surface tension and/or capillary forces during the drawing of the glass article. The surface tension and capillary forces provide a radial force that causes the annular passage to close. Using these forces during diameter reduction at draw causes the annular passage to close uniformly in the radial direction and increases symmetry in the resultant glass article. Thus, symmetry can be increased along the length of, for example, an optical fiber.

FIG. 3 shows a glass tube 50 that can be used in the present invention. The glass tube 50 preferably is the type of tube typically used in MCVD and PCVD processes and has an annular passage 60 defined by an inner surface 52. The inner diameter of the glass tube 50 preferably is between approximately 10 and 33 millimeters. The outer diameter of the glass tube 50, defined by its outer surface 54, preferably is between approximately 15 and 35 millimeters and more preferably is between approximately 21and 25 millimeters.

Initially, glass 51 preferably is provided on the inner surface 52 of the glass tube 50 to reduce the diameter of the annular passage 60. Preferably, the glass 51 is provided on the inner surface 52 by depositing soot particles on the inner surface and sintering the soot particles (e.g., a MCVD process). Alternatively, the glass 51 can be provided on the inner surface 52 by depositing glass particles on the inner surface (e.g., a PCVD process). As another alternative, the glass 51 can be provided by a sleeving technique. In this technique, a glass sleeve or tube (not shown) having an outer diameter slightly less than the inner diameter of glass tube 50 can be inserted into the glass tube 50. Other conventional processes could be used to provide glass 51 on the inner surface 52.

The glass 51 provides a first predetermined value α, which is a diameter of the annular passage 60 after glass 51 has been provided on the inner surface 52 divided by the outer diameter of the glass tube 50. The first predetermined value a is, in the case of depositing soot, determined after the soot has been sintered. The first predetermined value α preferably is at least approximately 0.7, more preferably is at least approximately 0.725, and even more preferably is at least approximately 0.75. Additionally, the first predetermined value α preferably is no more than approximately 0.9, more preferably is no more than approximately 0.875, and even more preferably is no more than approximately 0.85. After the addition of glass 51, the diameter of the annular passage 60 preferably is at least 2 millimeters smaller than the original inner diameter of tube 50. The preferred diameter of the annular passage 60 is in the range of approximately 10 to approximately. 33 millimeters, more preferably approximately 19 to approximately 23 millimeters, and most preferably approximately 17 to approximately 21 millimeters. The glass 51 preferably has a mass per unit length of approximately 5 to approximately 100 grams per meter. For example, a PCVD process normally deposits about 120 grams on a 21 mm ID by 25 mm OD tube, about 8 grams of which is core material and the rest is clad material.

Next, glass 53 is preferably provided on. the outer surface 54 of the glass tube 50 to increase the outer diameter. The glass 53 can be provided on the outer surface 54 by conventional techniques, such as depositing soot particles on the outer surface and sintering the soot particles, depositing glass particles on the outer surface, or a sleeving technique. As particular examples, conventional techniques such as VAD, OVD, and outside plasma vapor deposition (OPVD) could be used to provide glass 53. Other conventional processes could be used to provide glass 53 on the outer surface 54.

The glass 53 provides a second predetermined value β, which is the diameter of the annular passage 60 after providing glass 51 on the inner surface 52 divided by the outer diameter of the preform 70 after providing glass 53 on the outer surface 54. The second predetermined value β is, in the case of depositing soot, determined after the soot has been sintered. The second predetermined value β preferably is at least approximately 0.1, more preferably is at least approximately 0.15, and even more preferably is at least approximately 0.2. Additionally, the second predetermined value β preferably is no more than approximately 0.4, more preferably is no more than approximately 0.35, and even more preferably is no more than approximately 0.3. After the addition of glass 53, the outer diameter preferably is approximately 30 to 180 millimeters. The glass 53 preferably has a mass per unit length of more than approximately 1000 grams per meter. In increasing orders of preference, the mass per unit length can be 1500, 2000, and 3500 grams per meter.

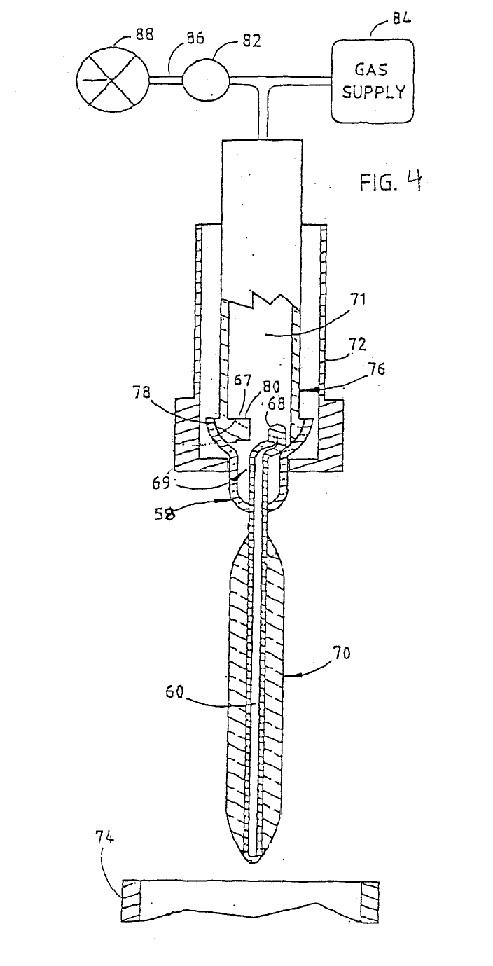

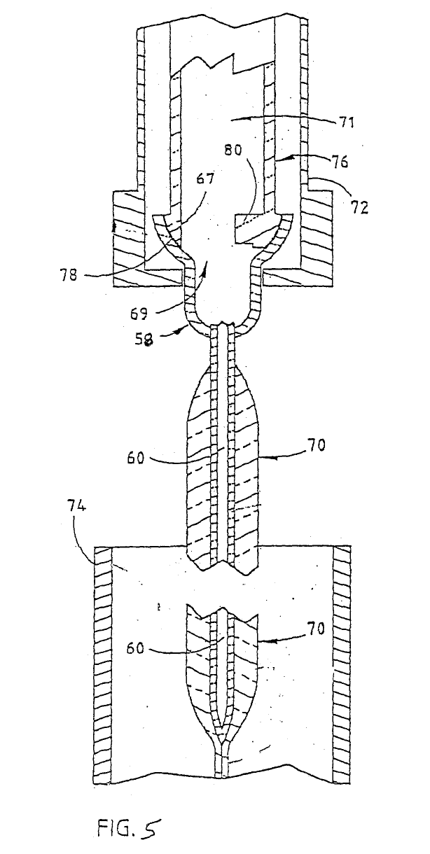

Preferably, before the glass tube 50 is removed from the apparatus (not shown) that provides glass or soot on the glass tube 50, a bent tab 68 (FIG. 4) is formed by conventional glass working to close one end of the annular passage 60. Also, the other end of the annular passage 60 is closed through conventional glass working.

As mentioned above, glass can be provided on glass tube 50 through various processes. When depositing glass particles or using a sleeving technique, the glass typically is provided on the tube 50 before entering the draw furnace 74 (see FIGS. 4 and 5). When soot particles are deposited, however, the soot particles can be turned into glass before or after entering the draw furnace 74, and additional steps, such as drying and sintering of the soot particles, may be needed. The description below relates to the formation of a preform 70 by applying soot particles to the tube 50.

The soot particles preferably are dried after deposition on the glass tube 50. For example, the soot particles can be dried in an atmosphere containing a chlorine drying gas. A preferred drying atmosphere contains up to two (2) percent Cl₂ and an inert gas. Preferably, the temperature of the drying atmosphere is between about 800 to about 1100°C. The drying step preferably lasts from about thirty (30) minutes to about four (4) hours, more preferably about two (2) hours. The particles can be dried before being placed in the draw furnace 74 or they can be dried in the draw furnace 74. When the soot particles are dried in the draw furnace 74, the drying step can be concluded with an inert gas purge of the draw furnace 74. Preferred purge gases include helium, nitrogen, argon, or mixtures thereof. However, any known inert gas may be used as the purge gas.

After drying, the soot particles are sintered into a dense glass by heating them to a temperature of no more than about 1700° C., preferably about 1400 to about 1500° C., and more preferably about 1450° C. The sintering step preferably lasts about 1 to about 6 hours, more preferably 2 to 4 hours. The atmosphere during sintering typically is also an inert atmosphere, where any conventional inert gas or mixture of gases including noble gases and nitrogen may be used. Preferably, helium is used as the sintering atmosphere. As with drying, the soot particles can be sintered before being placed in the draw furnace 74 or they can be sintered in the draw furnace 74.

The draw furnace 74 is provided, preferably in a vertical orientation, for drawing the glass preform 70 into a glass article, e.g., an optical fiber, while closing the annular passage 60. As shown in FIG. 4, the preform 70 is suspended by integral handle 58 on downfeed handle 72. The furnace 74 preferably employs a heat source (not shown) that is symmetric about the periphery of the preform 70. For example, in a preferred embodiment, the heat source is a vertically oriented cylindrical furnace having gradient heat zones. One such furnace employs heat zones of increasing temperature from top to bottom. Consequently, as the preform 70 is inserted into the top of the furnace and lowered into it, the annular passage 60 will close from the bottom.

A cylindrical inner handle 76, having a radially inwardly extending breaking tab 80, is mated with the integral handle 58 such that a lower mating surface 78 of inner handle 76 forms a substantially airtight seal with mating surface 67 of integral handle 58. Handle 76 has an interior cavity 71 and at its lower end includes a breaking tab 80 which extends radially inwardly such that relative rotation between integral handle 58 and inner handle 76 causes breaking tab 80 of inner handle 76 to engage the bent tab 68 of preform 70.

In one embodiment, glass preform 70 is lowered into draw furnace 74 (see FIG. 5) for a sufficient time period to increase the gas pressure within annular passage 60 of glass perform 70. Glass preform 70 is then removed from within furnace 74. A negative pressure is applied to interior cavity 71 of inner handle 76 and interior cavity 69 of integral handle 58, thereby removing contaminants such as H₂O as well as other particulate matter. The interior cavity 71 of inner handle 76 and the interior cavity 69 of integral handle 58 are then backfilled with a dry or drying gas from a gas supply 84. The gas can be a chlorine or fluorine containing gas, an inert gas, such as argon, helium, nitrogen, etc., and mixtures thereof. The gas may be intended to cause etching. If so, the gas preferably includes oxygen. The supply of dry or drying gases is preferably provided so that if any gas enters annular passage 60 of preform 70, it is a clean dry gas that will not lead to attenuation induced losses within the resultant optical fiber.

Annular passage 60 of preform 70 is then opened by snapping bent tab 68 of preform 70. To snap bent tab 68, inner handle 76 is rotated relative to integral handle 58 such that breaking tab 80 of inner handle 76 engages bent tab 68 of preform 70 to break tab 68. Breaking bent tab 68 of preform 70 exposes annular passage 60 of glass preform 70 to gas within interior cavity 69 of integral handle 58, thereby reducing or eliminating possible contamination of annular passage 60 before drawing of optical fiber from preform 70. For example, exposing the annular passage 60 to gas inhibits wetting of the annular passage 60, i.e., the exposure of hydrogen species (e.g. H, OH, H₂O, etc.) to the surface of the annular passage 60. While rotating inner handle 76 relative to integral handle 58 is preferred, integral handle 58 could be rotated with respect to inner handle 76. Further, both inner handle 76 and integral handle 58 could be rotated with respect to one another.

After snapping bent tab 68 from preform 70, a dry or drying gas is continuously passed into inner handle 76 thereby maintaining interior cavity 71 of inner handle 76, the interior cavity 69 of integral handle 58, and annular passage 60 of preform 70 free of contaminants and from being recontaminated. A valve 82 controls the flow of gas from the gas supply 84 and whether the gas is directed directly to interior cavity 71 of inner handle 76 or vented to an exhaust tube 86. Exhaust tube 86 is coupled with a one-way valve 88 that prevents the entry of air into exhaust tube 86 and the contamination of annular passage 60 of preform 70 by ambient air and the contaminant matter associated therewith. One-way valve 88 may be provided in the form of a bubbler, a check valve, or any other form of a one-way valve that prevents the backflow of ambient air into exhaust tube 86. Alternatively, exhaust tube 86 may be provided at such a substantial length that backflow of ambient air into exhaust tube 86 is prevented from reaching annular passage 60 of preform 70.

After the annular passage 60 of the preform 70 has been opened and purged, the preform 70 is lowered further into the hot zone of furnace 74 and/or the temperature is increased to a temperature sufficient to allow an optical fiber to be drawn from the preform 70. The temperature in the furnace 74 during draw is preferably in the range of approximately 1800 to approximately 2100° C., and more preferably approximately 1900 to approximately 2000° C. The preform 70 is preferably heated at a rate of at least approximately 20° C. per minute.

While preform 70 is being heated with furnace 74, a gob or sphere of molten glass (not shown) will begin to collect at the bottom end of the preform 70. If the annular passage 60 is constantly purged while the preform is heated within the hot zone, it may be necessary to decrease or eliminate the purge pressure of the dry or drying gas to prevent the enlargement and or rupture of the glass sphere. Allowing the glass sphere to rupture may allow the dry or drying gas to exit the preform 70 and hinder the closure of annular passage 60 and the formation of the optical fiber having a solid core. In addition, allowing sphere to rupture might allow ambient air to enter and contaminate annular passage 60 and the resultant optical fiber. The purge pressure of the dry or drying gas in annular passage 60 is therefore preferably maintained low enough during the drawing of the optical fiber from the preform 70 that the glass sphere does not rupture and further that, as the annular passage 60 closes during the draw, the gas present in the annular passage 60 can escape by flowing back through integral handle 58, thereby allowing the annular passage 60 to close without creating gas filled voids within the resultant fiber.

The preform 70 is drawn into optical fiber and the annular passage 60 closes. The optical fiber is preferably drawn at a rate within the range of approximately 1 to approximately 30 meters per second and, more preferably, approximately 4 to approximately 9 meters per second. As the preform 70 is drawn, the outside diameter of the preform 70 gradually reduces. Because the outside diameter of the preform 70 is sufficiently large with respect to the inside diameter of the annular passage 60, the forces internal to the preform 70 generated by this reduction of the outside diameter cause the annular passage 60 to close as well. The reduction in outside diameter of the preform 70 creates adequate surface tension and capillary forces, so that the annular passage 60 closes completely during the draw operation without having to resort to the use of any significant negative force, e.g., vacuum. In other words, the ratio of the outside diameter of the preform to the inside diameter of the annular passage 60 is great enough that, under sufficient reduction of the outside diameter, the annular passage 60 closes due to closure forces, including surface tension and capillary forces, without the need for significant negative pressure that would otherwise cause the annular passage 60 to close asymmetrically.

In particular, the annular passage is capable of closing completely during the fiber draw with low vacuum, preferably greater than 100 Torr, more preferably greater than 200 Torr, even more preferably greater than 400 Torr, and even more preferably greater than 500 Torr, applied to the annular passage during the draw. Most preferably, the pressure applied to the annular passage is about equal to atmospheric pressure (i.e., about 750-760 Torr) or even slightly positive (i.e., between about 761.8 and 769 Torr, more preferably about 764.4 Torr, where atmospheric pressure is assumed to be equal to 760 Torr) such as that caused by the purge pressure of the gas or drying gas entering annular passage 60. In this way, annular passage 60 can be maintained under pressure during the fiber drawing step which is sufficient to result in a circular geometry. Preferably, the surface tension at the point at which the annular passage closes is greater than a vacuum force at that point. The appropriate pressure will depend on other factors, such as draw speed, blank size, and draw temperature.

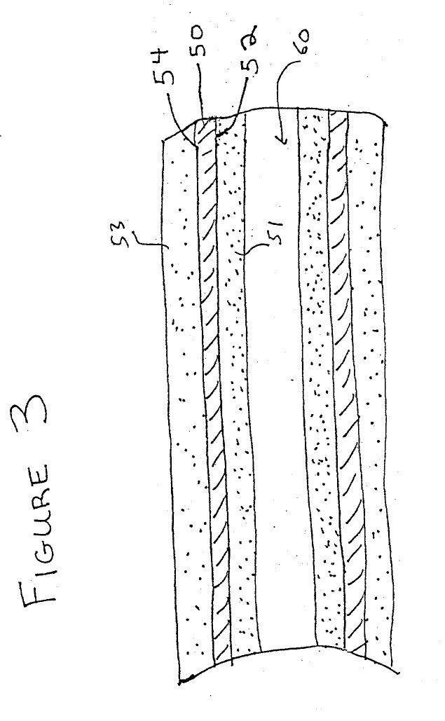

FIG. 2 shows the expected cross-sectional profile of an optical fiber 20 formed in accordance with the present invention. Notice the circular symmetry of the layers of glass 24 about the centerline 22. The symmetry shown decreases the PMD in optical fibers to below maximum acceptable levels for a given system. It is expected that the symmetry seen here will be present in the optical fiber drawn from the preform and will be consistent throughout the entire length of the optical fiber.

As mentioned above, the preform 70 should be structured such that the outer diameter of the preform 70 is sufficiently large with respect to the diameter of the annular passage 60 so that the forces internal to the preform 70 generated by reduction of the outside diameter cause the annular passage 60 to close. In other words, the predetermined value β should be selected to cause closure of the annular passage through surface tension and/or capillary forces, without the need for external forces, such as vacuum forces.

The preform 70 can be formed with the predetermined value β using techniques different from the technique described above. For example, glass 53 can be provided on the outer surface 54 of the glass tube 50 before glass 51 is provided on the inner surface 52. Alternatively, the initial configuration of the glass tube 50 can be such that glass need only be provided on the inner surface 52 to achieve the desired predetermined value β.

Using the methods disclosed herein, optical fibers can be achieved which have an outside diameter of 125 microns, yet the layers of glass surrounding the centerline are sufficiently symmetrical that, at a distance of about 0.1 micron from the centerline, the glass layers deposited have a radius which varies less than 0.025 microns, i.e., the maximum radius minus the minimum radius of any glass layer, located between about 0.08 to 0.15 microns from the centerline, is less than 0.025 microns, more preferably less than about 0.015 microns. Using the techniques disclosed herein, applicants have been able to achieve such fibers. Comparing the centerline profile of a fiber produced by the subject method to the centerline profile of a fiber produced by a conventional method, the centerline profile of the conventionally-manufactured fibers does not exhibit such uniform symmetry and concentricity of layers. Conversely, the fiber made in accordance with the invention exhibits concentric and symmetric regions of glass about its centerline.

A method of manufacturing a glass article has been described according to the present invention. Many modifications and variations may be made to the techniques and structures described and illustrated herein without departing from the spirit and scope of the invention. Accordingly, it should be understood that the methods described herein are illustrative only and are not limiting upon the scope of the invention.

What is claimed is:

1. A method of manufacturing an optical fiber, comprising the steps of:
providing a glass tube with an annular passage;
forming a preform by the steps of:
providing glass on an inner surface of the glass tube while maintaining the annular passage,
providing glass on an outer surface of the glass tube,
wherein the preform has a first predetermined value α that is a diameter of the annular passage after providing glass on the inner surface divided by an outer diameter of the glass tube, and the preform has a second predetermined value β that is the diameter of the annular passage after providing glass on the inner surface divided by an outer diameter of the preform after providing glass on the outer surface; and
drawing the preform into an optical fiber such that the annular passage closes during drawing.

2. The method of claim 1, wherein the step of providing glass on the inner surface comprises a technique selected from the group of techniques consisting of depositing soot particles on the inner surface and sintering the soot particles, depositing glass particles on the inner surface, and applying a glass sleeve to the inner surface.

3. The method of claim 1, wherein the step of providing glass on the inner surface comprises a deposition technique selected from the group of techniques consisting of modified chemical vapor deposition and plasma chemical vapor deposition.

4. The method of claim 1, wherein the step of providing glass on the outer surface comprises a technique selected from the group of techniques consisting of depositing soot particles on the outer surface and sintering the soot particles, depositing glass particles on the outer surface, and applying a glass sleeve to the outer surface.

5. The method of claim 1, wherein the step of providing glass on the outer surface comprises the steps of depositing soot particles on the outer surface, drying the soot particles, and sintering the soot particles.

6. The method of claim 5, wherein the soot particles are dried before drawing.

7. The method of claim 5, wherein the soot particles are dried during drawing.

8. The method of claim 1, wherein at least one end of the annular passage of the preform is open during drawing.

9. The method of claim 1, wherein the drawing step causes the annular passage to close substantially uniformly in the radial direction.

10. The method of claim 1, further comprising the step of exposing the annular passage to gas during drawing.

11. The method of claim 10, wherein the step of exposing the annular passage to gas inhibits wetting of the annular passage.

12. The method of claim 10, wherein a pressure of the gas in the annular passage is at least 500 Torr.

13. The method of claim 10, wherein a pressure of the gas in the annular passage is at least 760 Torr.

14. The method of claim 10, wherein the gas in the annular passage contains a gas selected from the group consisting of fluorinated gases, chlorinated gases, inert gases, and mixtures thereof.

15. The method of claim 1, further comprising the step of etching the annular passage during drawing.

16. The method of claim 1, wherein the first predetermined value α is at least approximately 0.7.

17. The method of claim 1, wherein the first predetermined value α does not exceed approximately 0.9.

18. The method of claim 1, wherein the second predetermined value β is at least approximately 0.1.

19. The method of claim 1, wherein the second predetermined value β does not exceed approximately 0.4.

20. The method of claim 1, wherein the first predetermined value α does not exceed approximately 0.9 and the second predetermined value β does not exceed approximately 0.4.

21. The method of claim 1, wherein the first predetermined value α is in the range of approximately 0.7 to approximately 0.9 and the second predetermined value β is in the range of approximately 0.1 to approximately 0.4.

22. The method of claim 1, wherein the first predetermined value α and the second predetermined value β are selected to ensure that the annular passage closes substantially uniformly in the radial direction during drawing.

23. The method of claim 1, wherein the outer diameter of the glass tube is in the range of approximately 15 to approximately 35 millimeters.

24. The method of claim 1, wherein the diameter of the annular passage after the step of providing glass on the inner surface is in the range of approximately 10 to approximately 33 millimeters.

25. The method of claim 1, wherein the outer diameter of the preform after the step of providing glass on the outer surface is in the range of approximately 30 to approximately 180 millimeters.

26. The method of claim 1, wherein a mass per unit length of glass provided onto the outer surface is more than approximately 1000 grams per meter.

27. The method of claim 1, wherein the step of drawing further includes heating the preform to a temperature in the range of approximately 1800 to approximately 2100° C.

28. The method of claim 27, wherein the preform is heated at a rate of at least approximately 20° C. per minute.

29. The method of claim 1, wherein the draw speed is in the range of approximately 1 to approximately 30 meters per second.

30. The method of claim 1, wherein the surface tension at the point at which the annular passage closes is greater than a vacuum force at that point during drawing.

31. A method of manufacturing a glass article, comprising the steps of:
providing a glass tube with an annular passage;
forming a preform by the steps of:
providing glass on an inner surface of the glass tube while maintaining the annular passage,
providing glass on an outer surface of the glass tube,
wherein the preform has a first predetermined value α that is a diameter of the annular passage after providing glass on the inner surface divided by an outer diameter of the glass tube, and the preform has a second predetermined value β that is the diameter of the annular passage after providing glass on the inner surface divided by an outer diameter of the preform after providing glass on the outer surface; and
drawing the preform into a glass article such that the annular passage closes during drawing.

32. The method of claim 31, wherein the first predetermined value α is in the range of approximately 0.7 to approximately 0.9.

33. The method of claim 31, wherein the second predetermined value β is in the range of approximately 0.1 to approximately 0.4.

34. The method of manufacturing an optical fiber, comprising the steps of:
providing a glass tube with an annular passage;
forming a preform by the steps of:
providing glass on at least an inner surface of the glass tube while maintaining the annular passage to provide the preform having a predetermined value β that is the diameter of the annular passage divided by the outer diameter of the preform; and
drawing the preform into an optical fiber such that the annular passage closes during drawing.

35. The method of claim 34, wherein the predetermined value β is in the range of approximately 0.1 to approximately 0.4.

36. The method of claim 34, wherein the step of providing glass comprises a technique selected from the group of techniques consisting of depositing soot particles and sintering the soot particles, depositing glass particles, and applying a glass sleeve.

37. The method of claim 34, wherein the step of providing glass includes providing glass on an outer surface of the glass tube.

38. An optical fiber made by the method of claim 1.

39. An glass article made by the method of claim 31.

40. An optical fiber made by the method of claim 34.

41. The optical fiber of claim 38, wherein said fiber is comprised of:
concentric layers of glass; and any glass layer between about 0.08 to about 0.15 microns from the centerline exhibits a change in radial dimension around its periphery which is less than 0.025 microns.

42. The optical fiber of claim 41, wherein said change in radial dimension is less than 0.015 microns.

43. The optical fiber of claim 40, wherein said fiber is comprised of:
concentric layers of glass; and any glass layer between about 0.08 to about 0.15 microns from the centerline exhibits a change in radial dimension around its periphery which is less than 0.025 microns.

44. The optical fiber of claim 43, wherein said change in radial dimension is less than 0.015 microns.
